(19) United States
(12) Patent Application Publication
(10) Pub. No.: US 2011/0101242 A1
(43) Pub. Date: May 5, 2011

(54) METHODS, APPARATUS AND SYSTEMS EMPLOYING MULTIPLE ENERGY SOURCES FOR ANALYZING COMPOSITIONS

(76) Inventors: Jason Dickens, Raleigh, NC (US); Dwight Sherod Walker, Durham, NC (US)

(21) Appl. No.: 12/999,338

(22) PCT Filed: Jul. 2, 2009
(86) PCT No.: PCT/US09/49514

§ 371 Date: Dec. 16, 2010

Related U.S. Application Data
(60) Provisional application No. 61/078,547, filed on Jul. 7, 2008.

(51) Int. Cl. G01N 21/64

(52) U.S. Cl. 250/459.1; 250/458.1; 250/461.1

(57) ABSTRACT

An apparatus for analyzing a composition includes an excitation source adapted to transmit incident energy, the excitation source comprising an array of energy emitting sources, and a plurality of photometric detectors adapted to receive radiation emitted from the composition when the incident radiation is transmitted thereto.

### FIELD OF THE INVENTION

The present invention relates generally to spectroscopic systems. More particularly, the invention relates to methods, apparatus and systems having multiple energy sources for detecting homogeneity and constituent concentration of compositions, and the density of mixtures.

### BACKGROUND OF THE INVENTION

A critical step in the preparation of a pharmaceutical composition, which often comprises a plurality of constituents or elements, including the active drug(s), is mixing or blending. Indeed, it is imperative that the pharmaceutical composition is homogenous and has the required density to ensure that the appropriate dosage of the active drug(s) is delivered to a recipient.

The homogeneity and, of course, constituent concentration of pharmaceutical compositions are thus critical factors that are closely monitored during processing. Various conventional methods have been employed to determine the homogeneity and constituent concentration of pharmaceutical compositions. Most of the conventional methods are, however, complex and time consuming.

The conventional methods typically involve stopping the blender and removing nine (9) or more samples from various locations in the blender. The samples are then taken to a laboratory and analyzed. The blender remains shut down while the samples are analyzed, which can take from 24 to 48 hours to complete.

Another time consuming aspect of the traditional methods is the hit or miss approach to determine when the mixture is homogeneous. Typically, the blender is run for a pre-determined amount of time. The blender is then stopped and the samples are removed and analyzed. If the mixture is not homogenous, the blender is run again and the testing procedure is repeated.

Further, the mixture may reach homogeneity at a time-point before the pre-determined set time for blending. In the first case more testing is carried out than is required, and in the second case valuable time is wasted in blending beyond the end-point. It is also possible that over blending can cause segregation of the constituents (or elements).

Finally, during compaction of the mixture, achieving the target density of the mixture is critical. Indeed, as is well known in the art, achieving the desired (or target) density of the composition is critical to achieving the proper weight and, hence, dose of the product.

Several apparatus and methods have been employed to detect on-line homogeneity. Illustrative are the apparatus and methods disclosed in PCT Pub. Nos. WO 02/18921 A2 and WO 01/29539 A1.

In PCT Pub. No. WO 02/18921 A2, methods and systems that utilize fluorescence emission to non-invasively analyze one or more constituents of a mixture are disclosed. Although the disclosed methods and systems overcome several of the above noted drawbacks associated with conventional methods and systems of determining homogeneity and concentration (i.e., potency) of constituents in pharmaceutical compositions, the methods and systems have several significant limitations. A major limitation is that the methods and systems are solely based on fluorescence emission from a single target element. Because of the short timescale of fluorescence, measurement of the time-resolved emission requires sophisticated and costly optics and electronics.

In PCT Pub. No. WO 01/29539 A1, a system for real-time fluorescent determination of constituents, i.e. trace elements, in compositions is disclosed. The system includes a fluorometer that is adapted to provide two lines of incident radiation (incident radiation pulses). According to the invention, the first line of incident radiation is directed toward and substantially perpendicular to a first sample (e.g., blister strip) and, hence, sample path (designated generally SP₁) and the second line of incident radiation is directed toward and substantially perpendicular to a second path (designated generally SP₂). The radiation transmission means can also be adapted to provide one line of incident radiation to facilitate a single (rather than dual) blister strip process.

The first control means of the system generates and provides a plurality of incident radiation pulses of different wavelengths, preferably, in the range of 200 to 800 nm. According to the invention, at least a respective one of the samples is illuminated with at least a respective one of the incident radiation pulses as it traverses a respective sample path SP₁, SP₂.

Although the noted system similarly overcomes many of the drawbacks associated with conventional methods of determining homogeneity and concentration of trace elements in pharmaceutical compositions, the system potentially has several limitations. The limitations include the requirement of fiber optic coupling and synchronization for data collection.

In U.S. Pat. No. 6,791,688, methods and systems for non-invasive luminescence analysis of compositions is disclosed. The disclosed methods and systems similarly overcome some of the aforementioned drawbacks associated with conventional methods and systems of determining homogeneity and concentration of trace elements in compositions; particularly, pharmaceutical compositions. However, the disclosed methods and systems similarly have several limitations. A significant limitation is that the methods and systems, as well as all known methods and systems that utilize luminescence emission to non-invasively analyze compositions containing one or more fluorophores (i.e. constituents or elements) are limited to the excitation and luminescent detection of a “single” fluorophore.

It is therefore an object of the present invention to provide methods and systems for real-time analysis of compositions containing one or more fluorophores that overcomes the disadvantages and drawbacks associated with conventional methods and systems for determining homogeneity and concentration of compositions containing multiple fluorophores.

It is another object of the present invention to provide methods and systems for real-time analysis of compositions containing one or more fluorophores that employ dynamic wavelength excitation, which facilitates multiple fluorophore steady-state detection.

It is another object of the present invention to provide methods and systems for real-time analysis of compositions containing one or more fluorophores that employ dynamic optical power control of incident radiation, which provides detection versatility to accommodate a wide concentration range without appreciable degradation in sensor performance.

### SUMMARY OF THE INVENTION

In accordance with the above objects and those that will be mentioned and will become apparent below, in one embodiment of the invention, the apparatus for analyzing a composition includes an excitation source adapted to transmit incident energy, the excitation source comprising an array of energy emitting sources, and a plurality of photometric detectors adapted to receive radiation emitted from the composition when the incident radiation is transmitted thereto.

In accordance with another embodiment of the invention, there is provided a system for use in analyzing a composition, the system comprising a sensor having an excitation source adapted to transmit incident energy, the excitation source comprising an array of energy emitting sources, and a plurality of photometric detectors adapted to receive radiation emitted from the composition when the incident radiation is transmitted thereto, the sensor being further adapted to provide at least one energy signal representing the emitted radiation; and control means in communication with the sensor for controlling the sensor and analyzing the energy signal.

In another embodiment of the invention, an apparatus for analyzing a composition, comprising an excitation source adapted to transmit incident energy, the excitation source comprising a first energy source array having a plurality of first energy emitting sources, and a second energy source array having a plurality of second energy emitting sources; and a plurality of photometric detectors adapted to receive radiation emitted from the composition when the incident radiation is transmitted thereto.

In accordance with another embodiment of the invention, there is provided a method for analyzing a composition, comprising the steps of (i) providing a sensor having an excitation source adapted to transmit incident energy, the excitation source comprising an array of energy emitting sources, and a plurality of photometric detectors adapted to receive radiation emitted from the composition when the incident radiation is transmitted thereto, (ii) transmitting the incident radiation to the composition, (iii) detecting the radiation emitted from the composition, (iv) and determining at least one characteristic of the composition from the detected radiation.

### BRIEF DESCRIPTION OF THE DRAWINGS

Further features and advantages will become apparent from the following and more particular description of the embodiments of the invention, as illustrated in the accompanying drawings, and in which like referenced characters generally refer to the same parts or elements throughout the views, and in which:

FIG. 1 is a perspective view of one embodiment of the luminescence apparatus, according to the invention;

FIG. 2 is a side plan view of the luminescence apparatus shown in FIG. 1;

FIG. 3 is a schematic view of one embodiment of a luminescence apparatus, illustrating the components thereof, according to the invention;

FIG. 4 is a schematic view of another embodiment of a luminescence apparatus, illustrating the components thereof, according to the invention;

FIG. 5 is a schematic illustration of a luminescence detection system, according to the invention;

FIGS. 6 and 7 are graphical illustrations of energy emission characteristics of radiation emitting sources of an LED array, according to the invention; and

FIGS. 8 and 9 are graphical illustrations of luminescence responses of a blend composition subjected to the energy emission shown in FIGS. 6 and 7.

### DETAILED DESCRIPTION OF THE INVENTION

Before describing the present invention in detail, it is to be understood that this invention is not limited to particularly exemplified embodiments, structures, apparatus, systems, materials or methods as such may, of course, vary. Thus, although a number of embodiments, apparatus, systems and methods similar or equivalent to those described herein can be used in the practice of the present invention, the preferred apparatus, systems and methods are described herein.

Although the methods, apparatus and systems of the invention are directed to light induced luminescence (LIL) and/or fluorescent (LIF) based methods and systems (and apparatus), it is to be understood that the present invention is not limited to the noted technologies or modes.

Similarly, although the methods, apparatus and systems of the invention are often described in connection with analyzing pharmaceutical compositions, it is to be understood that the present invention is not limited to analysis of such compositions.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a”, “an”, “the” and “one” include plural referents unless the content clearly dictates otherwise. Thus, for example, reference to “a sensor” includes two or more such sensors; reference to “a constituent” includes two or more such constituents and the like.

### DEFINITIONS

The term “luminescence”, as used herein, means the emission of light from a composition and/or a fluorophore or constituent thereof. As is well known in the art, the term “luminescence” includes fluorescence and phosphorescence, i.e., emission of light from triplet excited states.

The term “array”, as used herein, means and includes a plurality of energy, e.g. light, emitting sources. The energy emitting sources can be arranged in any pattern and need not be in direct communication with each other.

The terms “fluorophore” and “constituent”, “element”, as used in conjunction with a composition or mixture, mean and include any matter, which, when subjected to energy of a specific wavelength, e.g. light, will emit energy at a different, but equally specific, wavelength, e.g. phosphorescence.

The term “pharmaceutical composition”, as used herein, is meant to mean and include any compound or composition of matter or combination of active ingredients (i.e., medicaments), which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.), including, but not limited to, analgesics, e.g., codeine, dihydromorphine, ergotamine, fentanyl or morphine; anginal preparations, e.g., diltiazem; antiallergics, e.g., cromoglycate (e.g., as the sodium salt), ketotifen or nedocromil (e.g., as the sodium salt); antiinfectives, e.g., cephalosporins, penicillins, streptomycin, sulphonamides, tetracyclines and pentamidine; antihistamines, e.g., methapyrilene; anti-inflammatories, e.g., beclomethasone (e.g., as the dipropionate ester), fluticasone (e.g., as the propionate ester), flunisolide, budesonide, rofleponide, mometasone (e.g., as the furoate ester), ciclesonide, triamcinolone (e.g., as the acetonide) or 6α,9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., N-{2-[4-(3-phenyl-4-methoxyphenyl)aminophenyl]ethyl}-(R)-2-hydroxy-2-(8-hydroxy-2(1H)-quinolinon-5-yl)ethylamine, 3-(4-{[6-({(2R)-2-hydroxy-2-[4-hydroxy-3-(hydroxymethyl)phenyl]ethyl}amino) hexyl]oxy}butyl) benzenesulfonamide, 3-(3-{[7-({(2R)-2-hydroxy-2-[4-hydroxy-3-(hydroxymethyl) phenyl]ethyl}amino)heptyl]oxy}propyl)benzenesulfonamide, 4-{(1R)-2-[(6-{2-[(2,6-dichlorobenzyl)oxy]ethoxy}hexyl)amino]-1-hydroxyethyl}-2-(hydroxymethyl)phenol, 2-hydroxy-5-(1R)-1-hydroxy-2-{[2-(4-{[(2R)-2-hydroxy-2-phenylethyl]amino}phenyl) ethyl]amino}ethyl)phenylformamide, 8-hydroxy-5-{(1R)-1-hydroxy-2-[(2-{4-[(6-methoxy-1,1′-biphenyl-3-yl)amino]phenyl}ethyl)amino]ethyl}quinolin-2(1H)-one, albuterol (e.g., as free base or sulphate), salmeterol (e.g., as xinafoate), ephedrine, adrenaline, fenoterol (e.g., as hydrobromide), formoterol (e.g. as fumarate), isoprenaline, metaproterenol, phenylephrine, phenylpropanolamine, pirbuterol (e.g., as acetate), reproterol (e.g., as hydrochloride), rimiterol, terbutaline (e.g., as sulphate), 3-(phenylsulfonyl)-8-(piperazin-1-YL)quinoline, 2-[(2,4-dichlorophenyl)amino]-4-(trifluoromethyl)-n-(tetrahydro-2H-pyrna-4-ylmethyl)-5-pyrimidinecarboxamide, isoetharine, tulobuterol or 4-hydroxy-7-[2-[[2-[[3-(2-phenylethoxy)propyl]sulfonyl]ethyl] amino] ethyl-2(3H)-benzothiazolone; adenosine 2a agonists, e.g., 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g., as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy) acetyl]amino}pentanoyl)amino] propanoic acid (e.g., as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; corticosteroids, e.g., (6α,11β,16α,17α)-6,9-difluoro-17-{[(fluoromethyl) thio]carbonyl}-11-hydroxy-16-methyl-3-oxoandrosta-1,4-dien-17-yl 2-furoate, (6α,11β,16α, 17α)-6,9-difluoro-17-{[(fluoromethyl)thio] carbonyl}-11-hydroxy-16-methyl-3-oxoandrosta-1,4-dien-17-yl 4-methyl-1,3-thiazole-5-carboxylate, xanthines, e.g., aminophylline, choline theophyllinate, lysine theophyllinate or theophylline; therapeutic proteins and peptides, e.g., insulin or glucagon. Anti-diabetic medicaments can also be employed such as, but not limited to, 5-[[4-[2-(Methyl-2-pyridinylamino)ethoxy]phenyl]methyl]-2,4-thiazolidinedione (“rosiglitazone”) and N,N-dimethylimidodicarbonimidic diamide (“metformin”). The noted medicaments may also be employed in the form of salts, (e.g., as alkali metal or amine salts or as acid addition salts) or as esters (e.g., lower alkyl esters) or as solvates (e.g., hydrates) to optimize the activity and/or stability of the medicament. Combinations of any of the above medicaments can also be employed.

The term “pharmaceutical composition” also encompasses formulations containing combinations of active ingredients, including, but not limited to, salbutamol (e.g., as the free base or the sulphate salt) or salmeterol (e.g., as the xinafoate salt) or formoterol (e.g., as the fumarate salt) in combination with an anti-inflammatory steroid, such as a beclomethasone ester (e.g., the dipropionate) or a fluticasone ester (e.g., the propionate) or budesonide.

The “pharmaceutical compositions”, alone or in combination with other actives (or agents), typically include one or more added materials or constituents, such as carriers. For the purposes of the invention, the term “carriers” generally refer to substantially inert materials that are nontoxic and do not interact with other components of the composition in a deleterious manner, and also may encompass vehicles, excipients, and the like. These materials can be used to increase the amount of solids in particulate pharmaceutical compositions. Examples of suitable carriers include water, fluorocarbons, silicone, gelatin, waxes, and like materials, as well as excipients such as pharmaceutical grades of carbohydrates including monosaccharides, disaccharides, cyclodextrins, and polysaccharides (e.g., dextrose, sucrose, lactose, raffinose, mannitol, sorbitol, inositol, dextrins, and maltodextrins); starch; cellulose; salts (e.g., sodium or calcium phosphates, calcium sulfate, magnesium sulfate); citric acid; tartaric acid; glycine; low, medium or high molecular weight polyethylene glycols (PEG's); pluronics; surfactants; and combinations thereof.

One additional component that can be employed in a pharmaceutical composition is one or more “derivatized carbohydrates”. The term “derivatized carbohydrates” is used herein to describe a class of molecules in which at least one hydroxyl group of the carbohydrate group is substituted with a hydrophobic moiety via either ester or ethers linkages. All isomers (both pure and mixtures thereof) are included within the scope of this term. Mixtures of chemically distinct derivatised carbohydrates may also be utilized.

Suitably, the hydroxyl groups of the carbohydrate can be substituted by a straight or branched hydrocarbon chain comprising up to 20 carbon atoms, more typically up to 6 carbon atoms. The derivatized carbohydrates can be formed by derivitisation of monosaccharides (e.g. mannitol, fructose and glucose) or of disaccharides (e.g. maltose, trehalose, cellobiose, lactose and sucrose). Derivatized carbohydrates are either commercially available or can be prepared according to procedures readily apparent to those skilled in the art.

Non limiting examples of derivatized carbohydrates include cellobiose octaacetate, sucrose octaacetate, lactose octaacetate, glucose pentaacetate, mannitol hexaacetate and trehalose octaacetate. Further suitable examples include those specifically disclosed in patent application WO 99/33853 (Quadrant Holdings), particularly trehalose diisobutyrate hexaacetate. A particularly preferred derivatized carbohydrate is α-D cellobiose octaacetate.

In one embodiment, the aerodynamic size of the derivatized carbohydrates may be between 1 and 50 μm, and in another embodiment between 1-20 μm. The derivatized carbohydrates for use in the preparation of compositions in accordance with this invention are typically micronized but controlled precipitation, supercritical fluid methodology and spray drying techniques familiar to those skilled in the art may also be utilized.

In one embodiment, the derivatised carbohydrate may be present in a concentration of 0.01-50% by weight of the total composition, and in another embodiment from 1-20%. Other carriers such as, for example, magnesium stearate, can also be used in the formulations

The term “during processing”, as used herein, refers to any time during the production of a product from initial product component/ingredient formulation to final product delivery. “During processing” thus includes process development efforts, as well as, commercial manufacturing processes.

The term “active processing steps,” as used herein, refers to steps which involve actual processing of a pharmaceutical composition. In pharmaceutical processing, active processing steps can include bulk active production steps, bulk formulation steps (e.g., mixing, transportation, and the like) and fill and finishing steps (tablet and/or capsule formation).

The term “non-invasive,” as used herein, describes a measurement technique that does not require stopping or slowing down an active processing step while taking the measurement.

The term “on-line”, as used herein, means and includes data acquisition directly from a processing apparatus or during an active processing step.

The term “real-time”, as used herein, means and includes substantially simultaneously processing data as the data is received.

The present invention provides methods, apparatus and systems for analyzing compositions; particularly, pharmaceutical compositions (and mixtures thereof), which substantially reduce or eliminate the disadvantages and shortcomings associated with conventional methods and systems for analyzing compositions. As will be appreciated by one having ordinary skill in the art, the analyses can provide a variety of compositional information, such as the chemical identity of one or more trace elements in the pharmaceutical composition, the concentration of one or more trace elements, the uniformity and density of the pharmaceutical composition and other pertinent information.

As discussed in detail herein, the luminescence methods, apparatus and systems of the invention can be readily employed on-line, i.e. during processing, and in real-time to obtain the noted compositional information. According to the invention, various types of processing equipment can be configured to non-invasively analyze a pharmaceutical composition and/or mixtures thereof during processing using the luminescence methods and systems of the invention. As will be appreciated by one having ordinary skill in the art, the methods, apparatus and systems of the invention can also be used to analyze any number of different forms of mixtures (e.g., solids, slurries, etc.) and different constituents thereof.

The methods, apparatus and systems of the invention can also readily accommodate various analysis or measurement modes; particularly, light induced luminescence analysis. However, as will readily be appreciated by one having ordinary skill in the art, the methods, apparatus and systems of the invention afford alternative measurement modes beyond light induced luminescence analysis. Indeed, various minor adaptations, involving various energy emitting arrays, detectors, filters, and other optical elements, along with appropriate on-board logic, are capable of readily facilitating alternative measurement modes. These alternative measurement modes include, but are not limited to, UV-Vis photometry, refractive index and turbidity. Chemiluminescent measurements are also a direct measurement mode that can be accommodated by the methods, apparatus and systems of the invention.

Accordingly, in one embodiment of the invention, light induced luminescence analysis is employed in the methods, apparatus and systems of the invention.

Luminescence analysis has several features which make it particularly suitable for use in the methods, apparatus and systems of the present invention. Luminescence is the broad description of light emission that encompasses both phosphorescence and fluorescence. In both methods, the optically excited state of the analyte(s) lead to the emission of light.

Luminescence analysis also provides a strong luminescence signal that can result in high-detection sensitivity. Consequently, small concentrations of elements or constituents, in some instances, down to 0.1% or lower of the total mixture by weight, can readily be measured using the luminescence methods and systems of the invention.

Further, luminescence analysis can be conducted non-invasively. Thus, processes do not have to be stopped or slowed in any manner during luminescence analysis of a composition or mixture.

Additionally, luminescence analysis is a non-destructive technique; that is, the technique does not consume any material. Therefore, the composition of the material or mixture is generally unaffected by the analysis.

Additional advantages of luminescence analysis are realized by virtue of the unique energy or light emitting arrays of the invention. As is well known in the art, luminescence detection is generally governed by both the central frequency and energy intensity of the excitation light. Employing an array of light emitting diodes as the excitation source allows for fine tuning of both these parameters. The central frequency of excitation can be tuned to maximize the quantum efficiency of the measurement based on the analyte(s) while the energy of the excitation can be varied to ensure a high dynamic range of detection. Frequency control can be performed by way of varied doping levels in the LED devices and/or by temperature tuning the device. Energy control can be performed by the amount of power applied to the device and/or the number of devices energized.

As discussed in detail herein, one additional advantage of the invention is the provision of real-time radiation detection over several decades of fluorophore concentration of “multiple” fluorophores, i.e. trace elements or constituents, without significant degradation in measurement performance.

The luminescence methods, apparatus and systems of the invention will now be described in detail in reference to various embodiments.

In at least one embodiment of the invention, the methods, apparatus and systems of the invention employ dynamic optical power control of incident excitation radiation, which thereby is capable of affording a fluorescence advantage (i.e. enhanced signal response without a significant degradation in performance).

In one embodiment of the invention, the apparatus and system includes arrays having multiple energy or radiation emitting sources and multiple photometric detectors. In some embodiments, the arrays include light emitting diode arrays (LED arrays) or Laser Diode arrays (LD Arrays) as a dynamic light source.

The purpose of the light source array is two fold. First, an array affords autonomous dynamic control of the incident optical power, thereby leveraging the optical power relation to signal response, as described in Equation 1, i.e.

I_{L}=(P_{O})×(L)×(λ)×(φ)×(ε)×(c) Eq. 1

where:
I_{L}=the luminescent signal intensity;
P_{O}=supplied optical power;
L=optical path length;
λ=luminescent collection efficiency;
φ=fluor luminescent quantum efficiency;
ε=extinction coefficient of the luminescent species (i.e. fluor); and
c=concentration of the fluorophore.

Typically, dynamic control of optical power is achieved via drive current and actuation of each photon or radiation source within the array.

According to the invention, various light source diode arrays can be employed within the scope of the invention, including (i) arrays that contain diodes with fixed disparate energy characteristics, (ii) arrays that contain diodes (or photon radiation sources or elements) with fixed single energy characteristics, and (iii) arrays that contain diodes that are adapted to provide varying energy characteristics.

By the term “fixed disparate energy characteristics”, as used herein, it is meant to mean that each diode in the array is adapted to provide a fixed, but different wavelength of light.

By the term “fixed single energy characteristics”, as used herein, it is meant to mean that each diode in the array is adapted to provide the same fixed wavelength of light.

By the term “varying energy characteristics”, as used herein, it is meant to mean that each diode in the array is adapted to provide the same varied wavelengths of light or different varied wavelengths of light.

Arrays that contain diodes with disparate (and/or varying) energy (or wavelength) characteristics provide dynamic excitation of “multiple” fluorophores, wherein corresponding emission is captured with multiple photo detectors having appropriate optical filtering. Consequently, the multiple detectors also provide light source power variance correction often required for luminescent analytical measurement, real-time optical source diagnostics, and photo detector ambient light exposure protection.

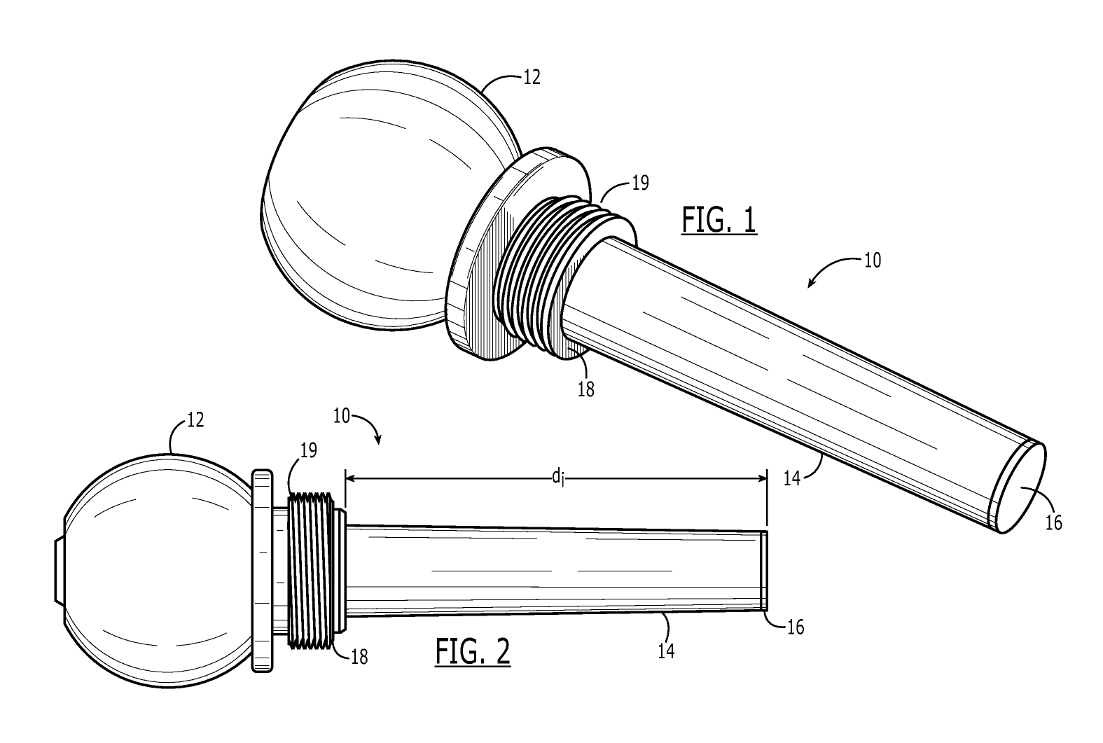

Referring now to FIGS. 1-3, there is shown one embodiment of a luminescence apparatus, i.e. sensor, 10 of the invention. Although the sensor 10 is described herein as a means for means of detecting luminescence, it is to be understood that the sensor 10 is not limited to one type or mode of measurement. Indeed, according to the invention, the sensor 10 can readily accommodate (or facilitate) various modes of measurement and mixed modes thereof, such as, for example, ultraviolet-visible absorbance and luminescence, ultraviolet-visible reflectance and luminescence, turbidity and luminescence, and refractive index and luminescence.

As illustrated in FIG. 1, the sensor 10 generally includes a first outer housing 12, which encases the sensor light source(s), detectors and associated electronics and circuitry (discussed below). Preferably, the noted sensor components and electronics are hermetically sealed in housing 12.

Sensor 10 further includes a second outer housing 14 having an insertion depth (designated “dᵢ”), i.e. region of sensor 10 that is adapted to be inserted into processing equipment. Disposed at the end of the second outer housing 14 is a window 16, preferably, a sapphire window.

According to the invention, the housings 12, 14 preferably comprise a light-weight, high strength material, such as stainless steel, Inconel® and Hatstelloy®. In a preferred embodiment of the invention, the housings 12, 14 comprise 316 stainless steel.

As further illustrated in FIGS. 1 and 2, the sensor 10 includes an engagement region 18, which is preferably disposed between the outer housings 12, 14. In the illustrated embodiment, the engagement region 18 includes threads 19 on the outer periphery thereof that are adapted to engage corresponding threads on a processing system, e.g., blender.

In this embodiment, by virtue of the minimal, small electronics employed, the size of the sensor 10 is typically less than 20 cm in length and 5 cm in diameter. Also, the sensor 10 may have a length less than 8.0 cm and a diameter less than 2.5 cm.

In this embodiment, one potential advantage of the sensor 10 of the invention is thus that the sensor 10 can be readily disposed in a 1 in. port on a blender (or mixer) or other processing equipment. Further, a DC voltage in the range of 3.3-36 volts may be employed for operation of the sensor 10.

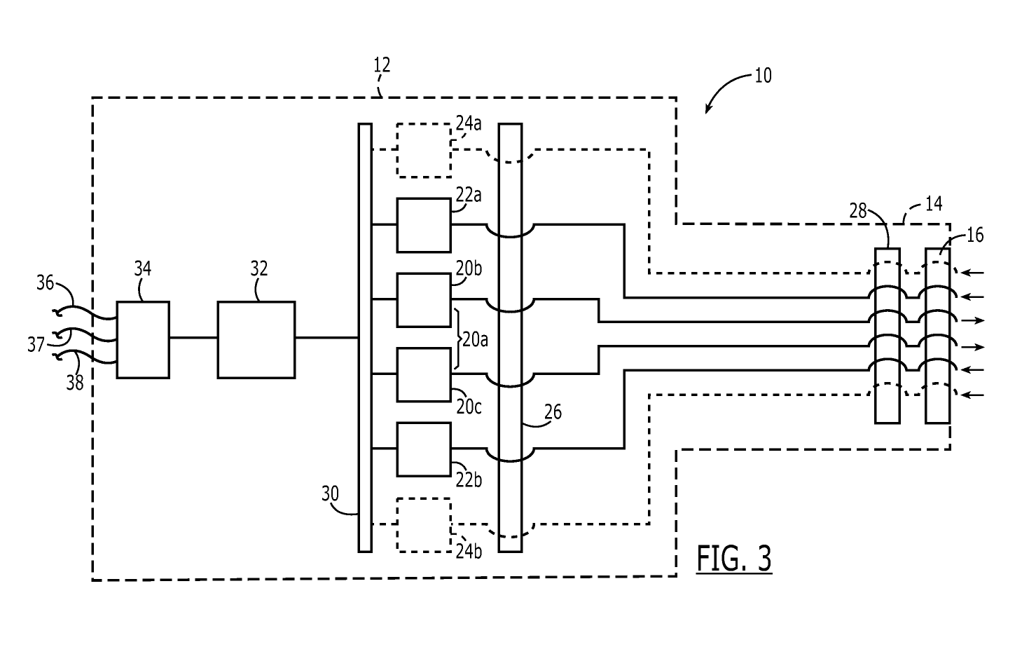

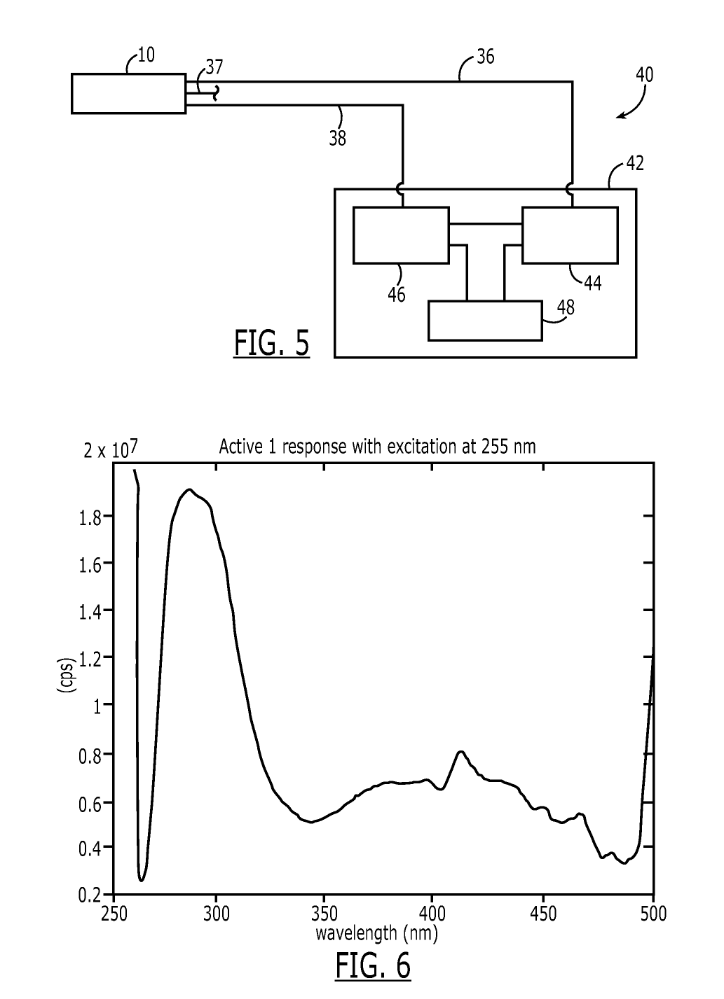

Referring now to FIG. 3, the electronic system and related circuitry for the sensor 10 will now be described in detail. As illustrated in FIG. 3, the sensor 10 includes a LED array 20a, a plurality of primary detectors 22a, 22b, optionally, a plurality of reference detectors 24a, 24b, an emission filter assembly 26, and a focusing lens assembly 28. The primary detectors 22a, 22b are adapted to detect luminescence radiation and convert the signal(s) to voltage, which preferably is further processed by analyzer 46 (see FIG. 5).

As illustrated in FIG. 3, the LED array 20a, primary detectors 22a, 22b, and reference detectors 24a, 24b, are connected to or disposed on a circuit board 30, which is in communication with power supply 32, which is in communication with a drive electronics circuit 34. Connected to the drive electronics circuit 34 are power 36, ground 37 and signal 38 leads.

According to the invention, various power supplies 32 can be employed within the scope of the invention. In one embodiment, the power supply 32 may provide in the range of approximately 100-900 volts, in another embodiment, in the range of about 300-600 volts.

Similarly, the LED array can comprise various light emitting sources. In one embodiment of the invention, the light emitting sources comprise LEDs. In one embodiment, the LEDs comprise ultraviolet light emitting diodes having a low wavelength, e.g., in the range of approximately 200-400 nm. In another embodiment, the LEDs comprise visible light emitting diodes having a wavelength in the range of approximately 400-650 nm.

In one embodiment, the LEDs have a power output in the range of 1-200 milliwatts. In another embodiment, the LEDs, have a power output in the range of 2-5 milliwatts.

As indicated, the sensor 10 includes an emission filter assembly 26, which is disposed between, the LED array 20a and the focusing lens assembly 28. In one embodiment of the invention, the emission filter assembly 26 includes a yellow visible filter. Although various filters can be employed within the scope of the present invention, Applicants believe that a yellow visible filter is capable of providing optimum filtration (or blocking) of the illumination pulse while allowing the desired signal to pass there through.

In one embodiment of the invention, an on-off switch (not shown) is connected to the drive electronic circuit 34 and/or power supply 32 via power lead 36 to control activation of the sensor 10. In some embodiments, the on-off switch is designed to activate the sensor 10 based on a predetermined position or positions of the processing apparatus, e.g., position of blender during its rotation cycle. Such switches are well known in the art and generally include a position-detection mechanism.

In another aspect, the on-off switch is designed to activate at predetermined time intervals. In another aspect, the on-off switch is designed to activate the sensor 10 based on a predetermined position of the processing apparatus and/or predetermined time interval(s).

In some embodiments of the invention, the sensor 10 is controlled by the control means 42 of the invention, as shown in FIG. 5. As discussed in detail below, and in one embodiment, the control means 42 preferably includes a control module 44 and analyzer 46 (referenced above).

As indicated, the luminescence methods and systems of the invention employ dynamic optical power control of incident excitation radiation, which thereby affords a fluorescence advantage. In some embodiments of the invention, the luminescence apparatus (and systems) include at least one array having multiple radiation emitting sources with disparate energy characteristics and multiple photometric detectors adapted to receive the radiation emitted from the target fluorophore(s) or element(s).

Such an embodiment is illustrated in FIG. 3, wherein array 20a includes two (2) radiation emitting sources or LEDs 20b, 20c and wherein the LEDs 20b, 20c have disparate energy characteristics, i.e. each LED 20b, 20c providing a different, predetermined wavelength of light that is capable of inducing a definitive luminescence response in at least one target element (or constituent). For example, to induce luminescence responses in a composition having [2S,3aS,6aS]-1-[(2S)-2-[[(1S)-1-(Ethoxycarbonyl)-3-phenylpropyl]amino]-1-oxopropyl]octahydrocyclopenta[b]pyrrole-2-carboxylic acid and 5-[[4-[2-(Methyl-2-pyridinylamino)ethoxy]phenyl]methyl]-2,4-thiazolidinedione, LED 20b would be adapted to provide light having a wavelength in the range of 240-260 nm to induce a luminescence response centered at 285 nm and LED 20c would be adapted to provide light having a wavelength in the range of 330-350 nm to induce a luminescence response centered at 390 nm.

To induce luminescence responses in a composition having 4-{(1R)-2-[(6-{2-[(2,6-Dichlorobenzyl)oxy]ethoxy} hexyl)amino]-1-hydroxyethyl}-2-(hydroxymethyl) phenol and 2-[(2,4-dichlorophenyl)amino]-4-(trifluoromethyl)-n-(tetrahydro-2H-pyrna-4-ylmethyl)-5-pyrimidinecarboxamide, LED 20b would be adapted to provide light having a wavelength in the range of 275-295 nm to induce a luminescence response centered at 310 nm, and LED 20c would be adapted to provide light having a wavelength in the range of 320-340 nm to induce a luminescence response centered at 420 nm.

According to the invention, the array, e.g., 20a, can include more that two (2) radiation emitting sources that provide predetermined wavelengths of light to induce luminescence responses in more than two (2) target elements. For example, to induce luminescence responses in a composition having [2S,3aS,6aS]-1-[(2S)-2-[[(1S)-1-(Ethoxycarbonyl)-3-phenylpropyl]amino]-1-oxopropyl]octahydrocyclopenta[b]pyrrole-2-carboxylic acid, 5-[[4-[2-(Methyl-2-pyridinylamino)ethoxy]phenyl]methyl]-2,4-thiazolidinedione and 3-(Phenylsulfonyl)-8-(piperazin-1-YL)quinoline, LED 20b would be adapted to provide light having a wavelength in the range of 240-260 nm to induce a luminescence response centered at 285 nm, LED 20c would be adapted to provide light having a wavelength in the range of 330-350 nm to induce a luminescence centered at 390 nm, and a third radiation emitting source, such as an LED, would be adapted to provide light having a wavelength in the range of 350-370 nm to induce a luminescence response centered at 510 nm.

As indicated above, since each radiation emitting source or LED comprises a narrow band light source, a single array or multiple arrays with varying excitation and emission combinations are required to accommodate the various target elements, i.e. fluorophores, with disparate luminescent spectral profiles. However, the majority of pharmaceutical and bio-pharmaceutical applications involve liquid and solid state measurements where the associated luminescence spectral profiles are broad and featureless throughout the ultraviolet-visible (UV-Vis) range. Thus, fluorophore families with similar luminescent spectral profiles are common in the liquid and solid state, thereby reducing the number of possible LED array combinations required (approximately <7) to address the majority of applications.

In some embodiments of the invention, the luminescence apparatus (and systems) include at least one array having multiple radiation emitting sources with single (fixed) energy characteristics and multiple photometric detectors adapted to receive the radiation emitted from the target fluorophore(s) or element(s). Such an embodiment is similarly illustrated in FIG. 3, wherein array 20a includes two (2) radiation emitting sources or LEDs 20b, 20c and wherein the LED 20b, 20c have similar fixed single energy characteristics.

In various embodiments, each LED 20b, 20c is capable of providing a pre-determined, suitable wavelength range of light (e.g., 200-800 nm) that is capable of inducing a luminescence response in at least one target element (or constituent).

According to the invention, the LEDs 20b, 20c can provide substantially steady-state energy (or light) or, as set for the in application Ser. No. 10/363,294 (now U.S. Pat. No. 7,277,168), which is incorporated by reference herein, radiation pulses of different wavelengths, for example, in the range of 200-800 nm. In some embodiments of the invention, the noted energy transmissions are controlled by the control means 42 of the invention (discussed below).

In some embodiments of the invention, the luminescence apparatus (and systems) include at least one array having multiple radiation emitting sources that are adapted to provide varying energy characteristics, such as laser diodes, and multiple photometric detectors adapted to receive the radiation emitted from the target fluorophore(s) or element(s). According to the invention, the radiation emitting sources can provide substantially similar varying energy characteristics or disparate energy characteristics by means of power and/or central wavelength.

Thus, by way of example, in one embodiment of the invention, two radiation emitting sources are employed; the first radiation emitting source providing a first wavelength range of light (e.g., 200-300 nm) that is capable of inducing a luminescence response in at least a first target element (or constituent) and second wavelength range of light that is capable of inducing a luminescence response in at least a second target element, the second radiation emitting source providing a third wavelength range of light that is capable of inducing a luminescence response in at least a third target element and fourth wavelength range of light that is capable of inducing a luminescence response in at least a fourth target element.

In some embodiments of the invention, the noted energy transmissions of the radiation emitting sources are similarly controlled by the control means 42 of the invention (discussed below).

In yet another embodiment of the invention, the sensor 10 includes at least two separate and distinct, i.e. different, arrays 20a and 20b to provide enhanced analysis capabilities, i.e. a hybrid sensor. According to the invention, each array 20a, 20b includes multiple radiation emitting sources 20e, 20f with fixed disparate energy characteristics or fixed single energy characteristics or varying energy characteristics, and multiple photometric detectors adapted to receive the radiation emitted from the target fluorophore(s) or element(s). In one embodiment of the invention, the radiation emitting sources 20e, 20f similarly comprise LEDs, such as LEDs 20 b, 20c, discussed above.

In some embodiments, the noted energy transmissions of the radiation emitting sources 20e, 20f are similarly controlled by the control means 42 of the invention (discussed below).

Referring now to FIG. 5, there is shown a schematic illustration of one embodiment of a luminescence detection system (designated generally 40) of the invention. The detection system 40 generally comprises the luminescence sensor 10, which is adapted to provide incident radiation to a composition (or mixture) and detect the luminescence (emission) radiation from one or more target elements in the composition and, control means 42.

As illustrated in FIG. 5, the control means 42 includes a control module 44 for controlling the power or drive current transmitted to the sensor 10 via power lead 36, an analyzer 46 for analyzing the emitted radiation detected by the sensor 10, which is communicated to the analyzer 46 via signal lead 38, and storage means 48 adapted to store detected emitted radiation and luminescence characteristics of known elements (or constituents) for comparison to detected emitted radiation.

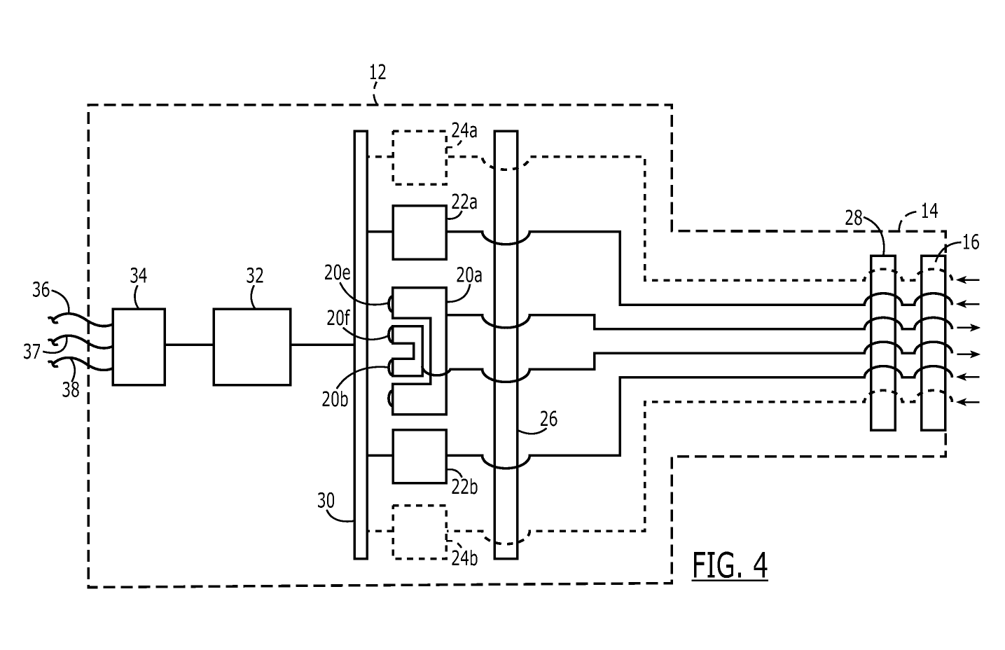

In one embodiment of operation, the system 40 is activated and a power input in the range of approximately 3.3-36 volts is transmitted to the sensor 10, thus activating the radiation emitting sources, e.g. LEDs 20b, 20c of array 20a shown in FIG. 3 (or LEDs 20e, 20f of arrays 20a, 20b shown in FIG. 4), whereby the subject composition (or mixture) is illuminated with incident radiation.

In response to the incident radiation, the target elements emit luminescent radiation, a portion of which detected by primary detectors 22a, 22b. The luminescence signals are then converted to a DC voltage and transmitted to the analyzer 46, wherein the voltage signal is processed to determine the desired compositional information (e.g., active identification, active content, etc.). The compositional information can further be employed as a signal in a closed-loop control system to actively control one or more of the processing steps or apparatus.

As stated above and set forth in U.S. Pat. No. 7,277,168 and PCT Pub. No. WO 02/18921 A2, which are expressly incorporated by reference herein, the sensor 10 and associated system 40 can be readily employed in various processing apparatus and systems, such as blending and compaction systems, and blister strip fill processes.

### EXAMPLES

The following example is provided to enable those skilled in the art to more clearly understand and practice the present invention. The example should not be considered as limiting the scope of the invention, but merely as being illustrated as representative thereof.

### Example 1

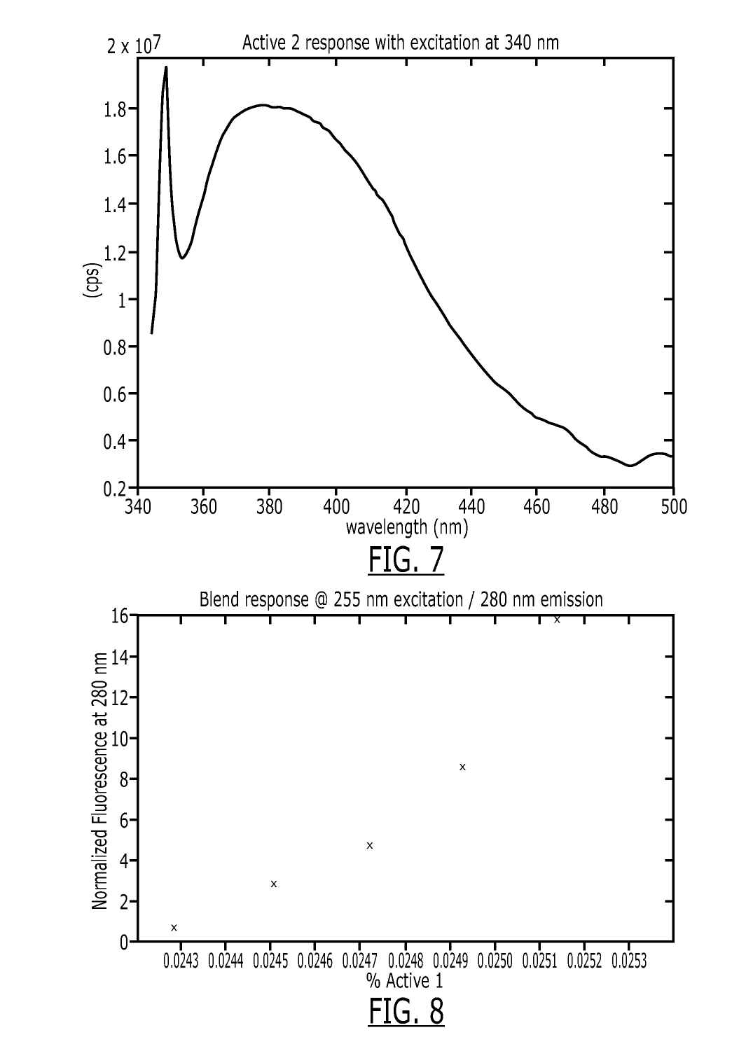

A blend composition having [2S,3aS,6aS]-1-[(2S)-2-[[(1S)-1-(Ethoxycarbonyl)-3-phenylpropyl]amino]-1-oxopropyl]octahydrocyclopenta[b]pyrrole-2-carboxylic acid (Active “1”) and 5-[[4-[2-(Methyl-2-pyridinylamino) ethoxy]phenyl]methyl]-2,4-thiazolidinedione (Active “2”) was subjected to luminescence analysis by the method of the invention and apparatus, i.e. sensor 10, illustrated in FIG. 3. LED 20b was adapted to provide light having a wavelength in the range of 240-260 nm to induce a luminescence response centered at 285 nm and LED 20c was adapted to provide light having a wavelength in the range of 330-350 nm to induce a luminescence response centered at 390 nm, as shown in FIGS. 6 and 7.

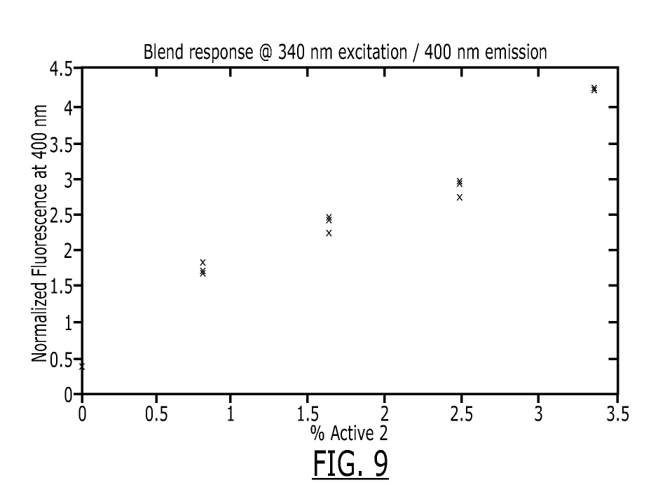

Referring now to FIGS. 8 and 9, there is shown the luminescence responses of the blend composition, i.e. Actives “1” and “2”. Referring first to FIG. 8, it can be seen that detection of Active “1” was readily achieved over a range of concentrations. FIG. 9 shows that detection of Active “2” was similarly readily achieved over a range of concentrations.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. An apparatus for analyzing a composition, comprising:
an excitation source adapted to transmit incident energy, said excitation source comprising an array of energy emitting sources; and
a plurality of photometric detectors adapted to receive radiation emitted from the composition when said incident radiation is transmitted thereto.

2. The apparatus of claim 1, wherein said energy emitting sources comprise light emitting diodes.

3. The apparatus of claim 2, wherein said light emitting diodes have fixed disparate energy characteristics.

4. The apparatus of claim 2, wherein said light emitting diodes have the same fixed energy characteristics.

5. The apparatus of claim 2, wherein said light emitting diodes have varying energy characteristics.

6. The apparatus of claim 2, wherein said light emitting diodes comprise ultraviolet light emitting diodes.

7. The apparatus of claim 6, wherein said ultraviolet light emitting diodes are adapted to transmit light having a wavelength in the range of approximately 200-400 nm.

8-10. (canceled)

11. The apparatus of claim 2, wherein said light emitting diodes have a power output in the range of approximately 2-5 milliwatts.

12-40. (canceled)

41. A method for analyzing a composition, comprising the steps of:
providing a sensor having an excitation source adapted to transmit incident energy, said excitation source comprising an array of energy emitting sources, and a plurality of photometric detectors adapted to receive radiation emitted from the composition when said incident radiation is transmitted thereto;
transmitting said incident radiation to the composition;
detecting said radiation emitted from the composition; and
determining at least one characteristic of the composition from said detected radiation.

42. The method of claim 41, wherein said energy emitting sources comprise light emitting diodes.

43. The method of claim 42, wherein said light emitting diodes have fixed disparate energy characteristics.

44. The method of claim 42, wherein said light emitting diodes have the same fixed energy characteristics.

45. The method of claim 42, wherein said light emitting diodes have varying energy characteristics.

46. The method of claim 42, wherein said light emitting diodes comprise ultraviolet light emitting diodes.

47. The method of claim 46, wherein said ultraviolet light emitting diodes are adapted to transmit light having a wavelength in the range of approximately 200-400 nm.

48-49. (canceled)

50. The apparatus of claim 42, wherein said light emitting diodes have a power output in the range of approximately 2-5 milliwatts.

51-69. (canceled)
